(19) United States
(12) Patent Application Publication
(10) Pub. No.: US 2022/0153020 A1
(43) Pub. Date: May 19, 2022

(54) SCALING FACTOR MATCHING BETWEEN RELATIVE SIZE-SCALED TEMPERATURE SENSOR PAIRS ACROSS THERMAL JET PRINTHEAD DIE THERMAL ZONES

(71) Applicant: Hewlett-Packard Development Company, L.P., Spring, TX (US)

(72) Inventors: Eric Thomas Martin, Corvallis, OR (US); Rogelio Cicili, San Diego, CA (US)

(73) Assignee: Hewlett-Packard Development Company, L.P., Spring, TX (US)

(21) Appl. No.: 17/417,841

(22) PCT Filed: Jul. 29, 2019
(86) PCT No.: PCT/US2019/043948

§ 371 Date: Jun. 24, 2021

(51) Int. Cl. B41J 2/045

(52) U.S. Cl. CPC B41J 2/04563; B41J 2/0458

(57) ABSTRACT

A thermal jet printhead die includes thermal zones. For each thermal zone, the printhead die includes a pair of relative size-scaled temperature sensors to differentially sense a temperature of the thermal zone. A scaling factor between the pair of relative size-scaled temperature sensors for each thermal zone is matched across the thermal zones.

### BACKGROUND

Thermal jet printing devices eject print material by using thermal energy or electricity to heat the print material. The print material may be print fluid such as ink in the case of thermal inkjet printing devices that form two-dimensional (2D) images on print media like paper. As another example, the print material may be that which is used in three-dimensional (3D) printing devices that form 3D objects in a layer-by-layer manner.

### BRIEF DESCRIPTION OF THE DRAWINGS

FIG. 1 is a block diagram of an example thermal jet printhead die.

FIG. 2 is a side-profile diagram of an example portion of a thermal jet printhead die.

FIG. 3 is a circuit diagram of an example relative size-scaled differential temperature sensor pair of a thermal zone of a thermal jet printhead die.

FIG. 4 is a circuit diagram of another example relative size-scaled differential temperature sensor pair of a thermal zone of a thermal jet printhead die.

FIG. 5 is a diagram of an example device-level implementation of a relative size-scaled differential temperature sensor pair of a thermal zone of a thermal jet printhead die.

FIG. 6 is a circuit diagram of analog circuitry common to the thermal zones of a thermal jet printhead die, in relation to one thermal zone.

FIG. 7 is a block diagram of an example thermal jet printhead die.

FIG. 8 is a block diagram of an example printing cartridge.

FIG. 9 is a block diagram of an example printing device.

### DETAILED DESCRIPTION

As noted in the background, thermal jet printing devices eject print material like ink by heating the print material. Such a printing device includes a thermal jet printhead die in which there are jet nozzles and corresponding firing resistors. Excitation of the firing resistor corresponding to a jet nozzle heats print material within a chamber, which causes a steam bubble to nucleate and eject a drop of the print material from the chamber through the nozzle. A single printhead die can include thousands of nozzles.

To minimize variation of the print material drops ejected by the different jet nozzles of a thermal jet printhead die, the firing resistors and the printhead die should be maintained at a uniform temperature. However, variations in manufacturing processes, variations in operating conditions, and other factors can result in temperature variation across the die. When uniform firing energy is applied to resistors in different regions of the printhead die, uniformity in the ejected drops may degrade, resulting in uneven print quality.

Techniques described herein employ fine-grain thermal sensing, in which the jet nozzles of a thermal jet printhead die are organized over thermal zones that have their temperatures separately monitored. There may be fewer than one-hundred thermal zones over which thousands of nozzles are organized, as one example. Individually monitoring the temperature of each zone permits a reduction in temperature variation across the die.

The thermal zones include temperature sensors. Manufacturing and other variations can cause variation in temperature measurement accuracy across the die. If each thermal zone includes one temperature sensor, one approach to match temperature response across the thermal zones is to match the temperatures sensors in physical size. The larger the temperature sensors, the better the sensors can be matched. A variation in the physical size of a given temperature sensor is a smaller percentage of the total sensor size.

Matching temperature sensor size is difficult with decreasing thermal jet printhead die size. There may be insufficient space on a printhead die to size the temperature sensors of the thermal zones sufficiently large to permit size matching to reduce temperature measurement variation within desired tolerances. The number of thermal zones over which the jet nozzles are organized may have to be decreased, with a corresponding reduction in spatial resolution of thermal control on the die.

Techniques described herein therefore employ a pair of differential temperature sensors in each thermal zone of a thermal jet printhead die. The sensors of the pair of each zone are size scaled in that the size of one sensor is larger than the size of the other sensor by a scaling factor. This relative scaling factor is matched across zones. Different zones can have nominally differently sized sensors, so long as the relative scaling factor between the sensors of each zone is matched. The sensors of each zone can be physically smaller in total size than a similarly matched sensor topology if each zone were to include just one sensor.

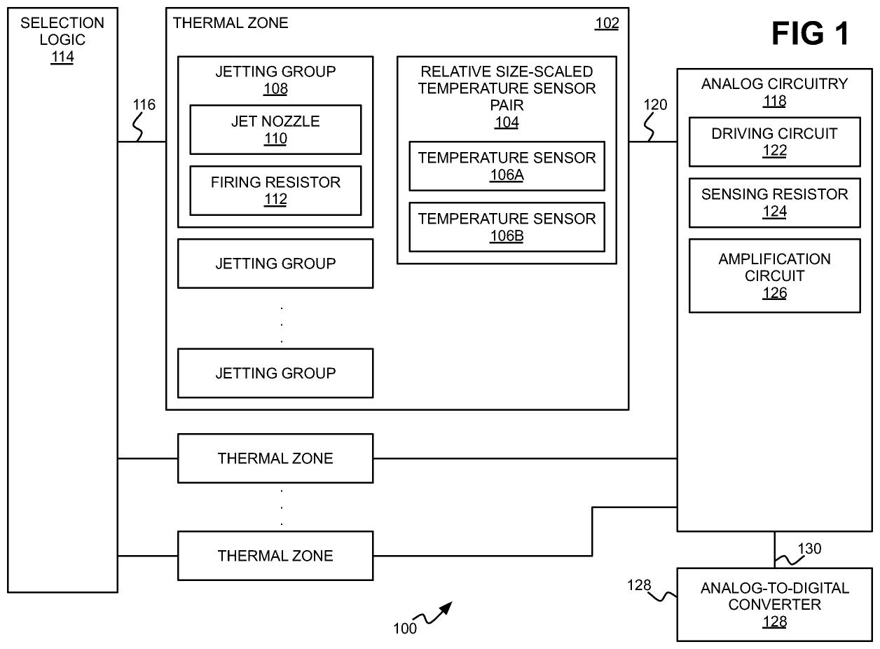

FIG. 1 shows an example thermal jet printhead die 100. The printhead die 100 includes a number of thermal zones 102. Each thermal zone 102 includes a relative size-scaled temperature sensor pair 104 of temperature sensors 106A and 1066, collectively referred to as the temperature sensors 106. Each thermal zone 102 includes a number of jetting groups 108 that each include a jot nozzle 110 and a corresponding firing resistor 112 to heat print material for ejecting through the nozzle 110.

As one specific example, the thermal jet printhead die 100 may include 4,224 jet nozzles 110 that are organized with their respective firing resistors 112 in jetting groups 108 over eighty-eight thermal zones 102. Each thermal zone 102 thus correspond to forty-eight jetting groups 108 encompassing forty-eight nozzles 110 and their respective resistors 112. There may be more or fewer jet nozzles 110, more or fewer thermal zones 102, and/or more or fewer jetting groups 108, however.

The relative size-scaled temperature sensor pair 104 corresponding to a thermal zone 102 measures or senses the temperature of the zone 102. The temperature sensor pair 104 is relative size-scaled in that the temperature sensor 1066 has a physical size that is larger than a physical size of the temperature sensor 106A by a scaling factor, such as eight. The relative size of the sensor 1066 to the size of the sensor 106A is matched across the thermal zones 102.

Regardless of any differences in the actual sizes of the temperature sensor 106B and 106A in any given thermal zone 102, then, the scaling factor in each zone 102 is constant to a desired tolerance across the zones 102. The actual size of each sensor 106 in any zone 102 can thus vary, so long as the relative size of the sensor 106B to the size of the sensor 106A in each zone 102 is equal to the scaling factor. The actual sizes of the sensors 106 do not therefore have to be as well matched across thermal zones 102.

The temperature sensor pair 104 corresponding to a thermal zone 102 differentially measures or senses the temperature of the zone 102. The temperature sensors 106 each provide or sense values, such as voltage, that are dependent on their temperature, and thus the temperature of their zone 102. The difference between the values of the sensors 106 therefore rises and falls with the temperature of their thermal zone 102, permitting differential temperature measurement or sensing of the zone 102. The sensors 106 can include temperature-dependent devices, such as temperature-dependent diodes or bipolar junction transistors (BJTs).

The temperature sensors 106 of a thermal zone 102 differ in physical size so that the differences in their temperature-dependent values vary by the same scaling factor. The value of each sensor 106 in a zone 102, such as its voltage, is dependent on its temperature and its physical size. Because the temperature sensor pair 104 of every thermal zone 102 has the same relative scaling factor between its constituent sensors 106, monitoring zone temperature differentially between the sensors 106 reduces the effects of physical sensor size variations among the zones 102.

The thermal jet printhead die 100 includes selection logic 114 that is connected to the thermal zones 102 by corresponding selection lines 116. The selection line 116 between each zone 102 and the selection logic 114 may represent a single connection. The selection logic 114 includes circuitry that asserts the selection line 116 of a selected thermal zone 102, enabling the temperature sensor pair 104 of this zone 102.

The thermal jet printhead die 100 includes analog circuitry 118 that is connected to the thermal zones 102 by corresponding lines 120. The line 120 between each thermal zone 102 and the analog circuitry 118 may represent multiple connections. The analog circuitry 118 is common to the zones 102 depicted in FIG. 1; there can thus be one analog circuitry 118 for the zones 102 depicted in FIG. 1. In another implementation, the printhead die 100 may include thermal zones other than the zones 102 and having their own common analog circuitry like the circuitry 118. The analog circuitry 118 drives the temperature sensor pair 104 of the currently selected thermal zone 102, and in turn amplifies the differentially sensed temperature of this zone 102 as measured by the sensor pair 106.

The analog circuitry 118 includes a driving circuit 122, a sensing resistor 124 that can be in series with the temperature sensor 106B, and an amplification circuit 126. The driving circuit 122 drives the temperature sensors 106 of the currently selected thermal zone 102, such as by providing an equal electrical current through each sensor 106. A voltage drop over the sensing resistor 124 is proportional to the temperature of the thermal zone 102, as sensed by the temperature sensors 106. The amplification circuit 126 amplifies this voltage drop, providing an amplified analog signal corresponding to the differentially sensed temperature of the selected zone 102.

The thermal jet printhead die 100 can include an analog-to-digital converter (ADC) 128 that is connected to the analog circuitry 118 by lines 130. The analog circuitry 118 provides on the lines 130 the amplified analog signal corresponding to the temperature of the thermal zone 102 currently selected by the selection logic 114. The ADC 128 in turn converts this analog signal to a digital value of the differentially sensed temperature of the currently selected zone 102.

The firing resistors 112 may be electrically excited in correspondence with the monitored temperatures of the thermal zones 102 when print material is to be ejected by their respective jet nozzles 110. Print material drop variation can thus be minimized, which in turn improves quality of the resulting image formed by the ejected print material. Each resistor 112, in other words, is electrically excited based on the sensed temperature of the zone 102 in which it is located. For example, the energy delivered to a firing resistor 112 may be modulated per locally sensed temperature (i.e., the temperature of the thermal zone 102 in which the resistor 112 is located), so that nozzles 110 at different temperatures can nevertheless eject drops of print material at high uniformity.

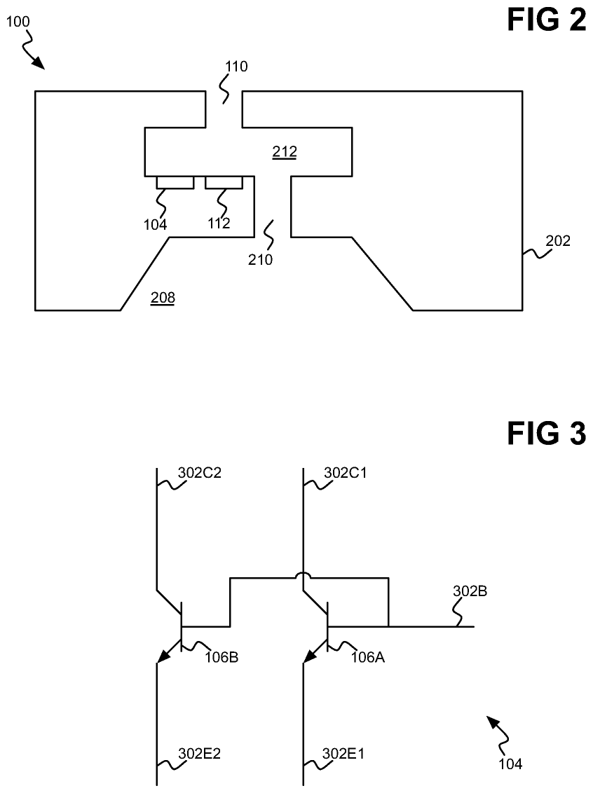

FIG. 2 shows a side profile of an example portion of the thermal jet printhead die 100. FIG. 2 depicts one jet nozzle 110 and one firing resistor 112, and a temperature sensor pair 104 spanning the jetting group 108 of FIG. 1 that includes the nozzle 110 and the resistor 112, among other jetting groups 108, which may be normal to the plane of FIG. 2. The printhead die 100 includes layers 202.

The layers 202 have a print material feed slot 208 formed therein, in fluidic communication with a print material feed channel 210 also formed in the layers 202. The channel 210 fluidically connects the slot 208 with a print material chamber 212 formed in the layers 202. The print material chamber 212 in turn is fluidic communication with the jet nozzle 110, which is also formed in the layers 202.

During printing, print material flows from the print material feed slot 208 via the print material feed channel 210 to the print material chamber 212. The jet nozzle 110 is operatively associated with the firing resistor 112. Excitation or energization of the firing resistor 112, which is formed in the layers 202, ejects a drop of print material from the print material chamber 212 through the jet nozzle 110.

The temperature sensor pair 104 is also formed in the layers 202. The sensor pair 104 differentially senses the temperature of the layers 202 of the thermal zone 102 in which the pair 104 is disposed. The sensed temperature correlates to the temperature of the print material in the chamber 212 and the temperature of the firing resistor 112 depicted in FIG. 2. The sensed temperature further correlates to the temperature of the print material in chambers 212 for jet nozzles 110 of other jetting groups 108 of FIG. 1 that the sensor pair 104 spans, as well as the temperatures of the firing resistors 112 of these other jetting groups 108. The sensor pair 104 thus senses the temperature of a corresponding thermal zone 102 that encompasses these jetting groups 108.

FIG. 3 is a circuit diagram of an example of the relative size-scaled temperature sensor pair 104 for a thermal zone 102 of the thermal jet printhead die 100. The temperature sensors 106A and 106B are respectively represented as BJTs. The base regions of the BJT-implemented sensors 106 are electrically connected to one another.

FIG. 3 identifies a base line 302B connected to the base regions of the BJT-implemented sensors 106. FIG. 3 also identifies collector lines 302C1 and 302C2 respectively connected to the collector regions of the BJT-implemented sensors 106A and 106B, and emitter lines 302E1 and 302E2 respectively connected to the emitter regions of the sensors 106A and 106B. The lines 302B, 302C1, 302C2, 302E1, and 302E2 are collectively referred to as the lines 302, which can constitute the lines 120 of FIG. 1 that connect the analog circuitry 118 to the thermal zone 102 of the sensor pair 104 of FIG. 3.

In operation, the temperature sensors 106 are each driven by the same current; the same current flows through each sensor 106. The voltage between the base and emitter regions of each sensor 106 is dependent on both temperature and (absolute) physical sensor size. The voltage between the base and emitter regions of the sensor 106A is greater than the voltage between the base and emitter regions of the sensor 106B by the scaling factor, because the size of the sensor 106B is larger than the size of the sensor 106A by the scaling factor. The difference between these two voltages is thus dependent on temperature and just the relative size (i.e., the scaling factor) between the sensors 106. The voltage differential is less dependent on the absolute physical sensor sizes of the sensors 106.

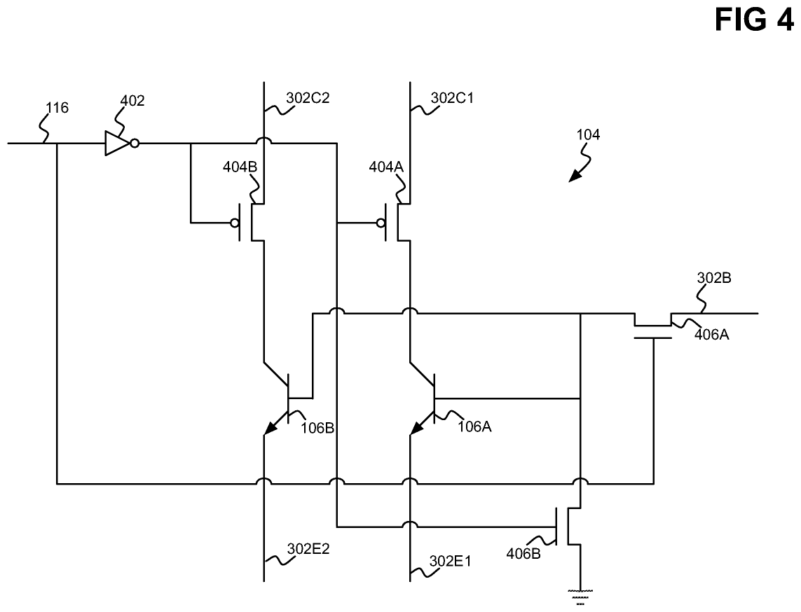

FIG. 4 is a circuit diagram of another example of the relative size-scaled temperature sensor pair 104 for a thermal zone 102 of the thermal jet printhead die 100. The difference between FIG. 3 and FIG. 4 is that the selection line 116 connecting the thermal zone 102 to the selection logic 114 is depicted in FIG. 4. Because every thermal zone 102 is connected to the analog circuitry 118 in FIG. 1, in actual implementation the thermal zones 102 are switchably isolated from the circuitry 118 except for the thermal zone 102 that has been selected by assertion of its corresponding selection line 116.

The selection circuitry in FIG. 4 includes an invertor 402 that connects the selection line 116 to transistors 404A and 404B and thus controls the transistors 404A and 404B. The transistors 404A and 404B are collectively referred to as the transistors 404 and may be field-effect transistors (FETs) like metal-oxide semiconductor FETs (MOSFETs), such as p-type MOSFETs (pMOSFETs) in the example of FIG. 4. The transistors 404A and 404B are respectively connected in series with the BJT-implemented temperature sensors 106A and 106B. The transistor 404A selectively isolates the sensor 106A from its collector line 302C1 until the selection line 116 is asserted. The transistor 404B selectively isolates the sensor 106B from its collector line 302C2 until the selection line 116 is asserted.

The selection circuitry in FIG. 4 further includes transistors 406A and 406B, collectively referred to as the transistors 406 and which may also be FETs like MOSFETs, such as n-type MOSFETs (nMOSFETs) in the example of FIG. 4. The transistor 406A is connected to the selection line 116, whereas the transistor 406B is connected to the selection line 116 via the inverter 402 and thus is controlled by the inverter 402. The transistors 406 selectively isolate the base terminals of the sensors 106 from their base line 302B when the thermal zone 102 to which the sensor pair 104 of FIG. 4 corresponds is not selected (i.e., when the selection line 116 of FIG. 4 is not asserted).

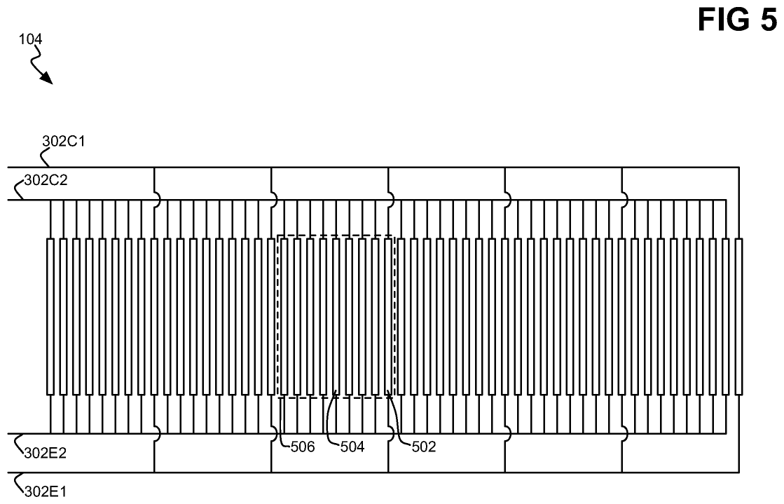

FIG. 5 shows an example device-level implementation of a relative size-scaled differential temperature sensor pair 104 for a thermal zone 102 of the thermal jet printhead die 100. The sensor pair 104 includes a number of temperature-sensing devices 502 electrically connected in parallel between lines 302C1 and 302C2, and a number of temperature-sensing devices 504 electrically connected in parallel between lines 302C2 and 302E2. The devices 502 and 504 have the same physical size, and may be temperature-dependent diodes or BJTs. For illustrative clarity, the base terminals of the devices 502 and 504, and thus the base line 302B, are not depicted in FIG. 5.

The temperature-sensing devices 502 constitute the temperature sensor 106A of the temperature sensor pair 104. The temperature-sensing devices 504 constitute the temperature sensor 106B of the temperature sensor pair 104. The number of devices 504 is equal to the number of devices 502 multiplied by the scaling factor. Because the devices 502 and 504 are identically sized, the size of the resulting sensor 106B is larger than the size of the resulting sensor 106A by the scaling factor.

The temperature-sensing devices 502 are spatially interleaved with the temperature-sensing devices 504 over contiguous device groups 506. Each group 506 includes one device 502 and a number of devices 504 equal to the scaling factor. More generally, in each group 506 the number of devices 504 is equal to the number of devices 502 multiplied by the scaling factor. The usage of multiple temperature-sensing devices 502 and 504 to implement the temperature sensors 106 as in FIG. 5 is an example way to realize the temperature sensor pair 104 so that the sensor 106B is larger than the sensor 106A by the scaling factor.

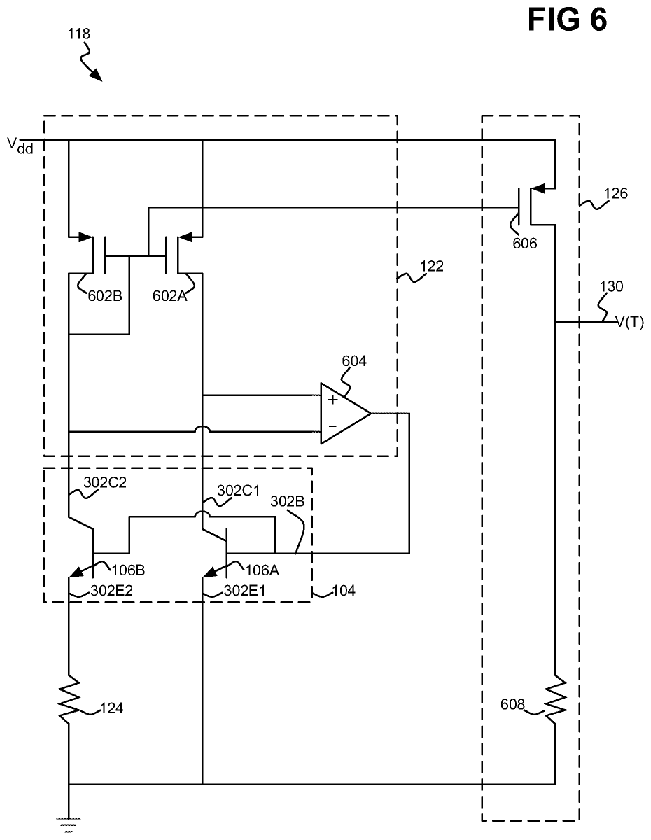

FIG. 6 is a circuit diagram of an example of the analog circuitry 118 that is common to the thermal zones 102 of the thermal jet printhead die 100, in specific relation to the relative size-scaled temperature sensor pair 104 of one such zone 102 as implemented per FIG. 3. FIG. 6 shows the electrical components that can constitute the driving circuit 122 and the amplification circuit 126 of the analog circuitry 118. FIG. 6 shows how the lines 302 identified in FIG. 3 can be connected to the analog circuitry 118. For illustrative clarity and convenience, the selection circuitry for the temperature size pair 104 of the thermal zone 102 particularly depicted in FIG. 6, such as the selection circuitry of FIG. 4, is not shown in FIG. 6. It is also noted that while the sensor pair 104 is depicted in FIG. 6, it is not actually part of the analog circuitry 118.

The driving circuit 122 drives a current through the BJT-implemented sensors 106, and includes transistors 602A and 602B respectively connecting the sensors 106A and 106B to a voltage source Vdd. The transistors 602A and 602B are collectively referred to as the transistors 602. The transistors 602 can be FETs like MOSFETs.

The driving circuit 122 includes an operational amplifier (opamp) 604. The inputs of the opamp 604 are connected to the collector regions of the BJT-implemented sensors 106, and the output of the opamp 604 is connected to the base regions of the sensors 106. The opamp 604 balances the current through each sensor 106 so that the current through each sensor 106 is identical.

The sensing resistor 124 of the analog circuitry 118 is connected in series with the BJT-implemented sensor 106B of the sensor pair 104. The voltage drop over the sensing resistor 124 is proportional to the differential voltage between the voltage between the base and emitter of the sensor 106B and the voltage between the base and emitter of the sensor 106A. The voltage drop over the sensing resistor 124 is therefore proportional to the temperature sensed by the temperature sensor pair 104.

The amplification circuit 126 amplifies the voltage drop over the sensing resistor 124. The amplification circuit 126 includes a transistor 606 in series with a resistor 608 between the voltage source Vdd and ground. The transistor 606 can be a FET like a MOSFET. The output V(T) of the amplification circuit 126 is an analog signal representing this amplified voltage, which is a function of temperature. The output V(T) is at the line 130 that connects the analog circuitry 118 to the ADC 128 in FIG. 1.

The output V(T) is equal to the product of the voltage drop over the sensing resistor 124, the ratio of the resistance of the resistor 608 to the sensing resistor 124, and the ratio of the current through the resistor 608 to the current through each temperature sensor 106. The transistor 606 can be sized relative to the transistors 602 so that the current the transistor 606 drives through the resistor 608 is greater than the current the transistors 602 drive through their respective sensors 106 by a current factor, such as four. The resistor 608 can be sized relative to the sensing resistor 124 so that the resistance of the resistor 608 is greater than the resistance of the sensing resistor 124 by a resistance factor, such as seven. The amplification circuit thus provides amplification equal to the product of the current and resistance factors, such as twenty-eight.

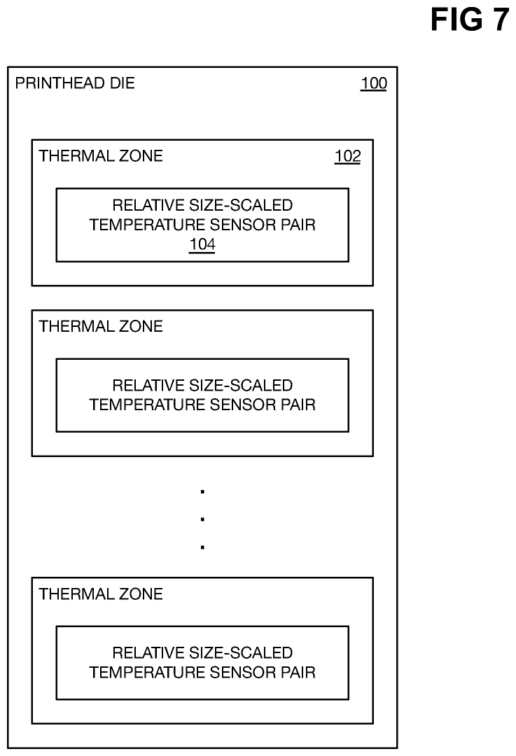

FIG. 7 shows the example thermal jet printhead die 100. The printhead die 100 includes thermal zones 102. For each thermal zone 102, the printhead die 100 includes a pair of relative size-scaled temperature sensors 104 to differentially sense a temperature of the thermal zone 102. A scaling factor between the pair of temperature sensors 104 for each thermal zone 102 is matched across thermal zones 102.

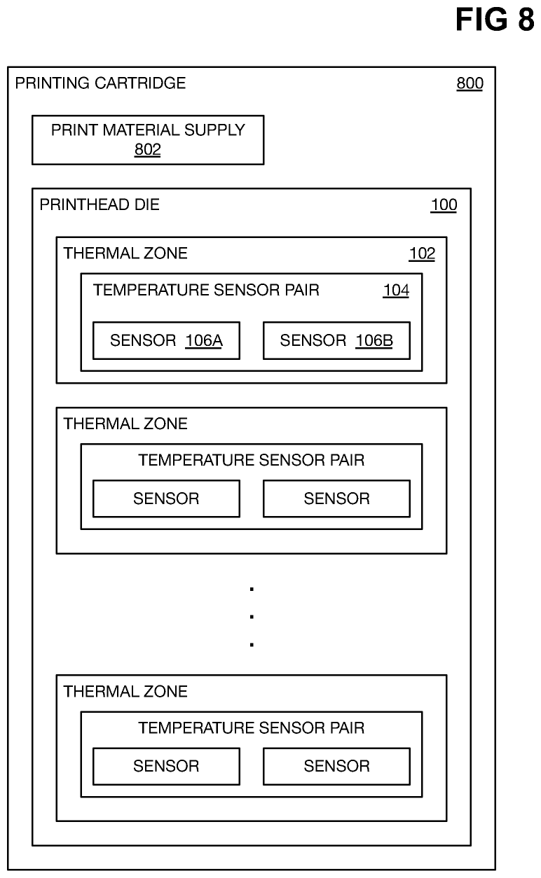

FIG. 8 shows an example thermal jet printing cartridge 800 for a printing device. The cartridge 800 includes a supply of print material 802 and a thermal jet printhead die 100 to selectively eject the print material. There may be more than one printhead die 100 on the cartridge 800. The supply of print material 802 may be removable from the printhead die 100. The cartridge 800 may include print material 802 of a singular type, such as just black colorant. The cartridge 800 may include print material 802 of different types, such as cyan, magenta, and yellow colorant. In the latter case, there may be a printhead die 100 for the print material 802 of each type.

The printhead die 100 includes, for each of a number of thermal zones 102, a pair of temperature sensors 104 to differentially sense a temperature of the thermal zone 102. The temperature sensor pair 104 of each thermal zone 102 includes sensors 106A and 106B. The scaling factor of the size of the sensor 1066 to the size of the sensor 106A is constant across the thermal zones 102.

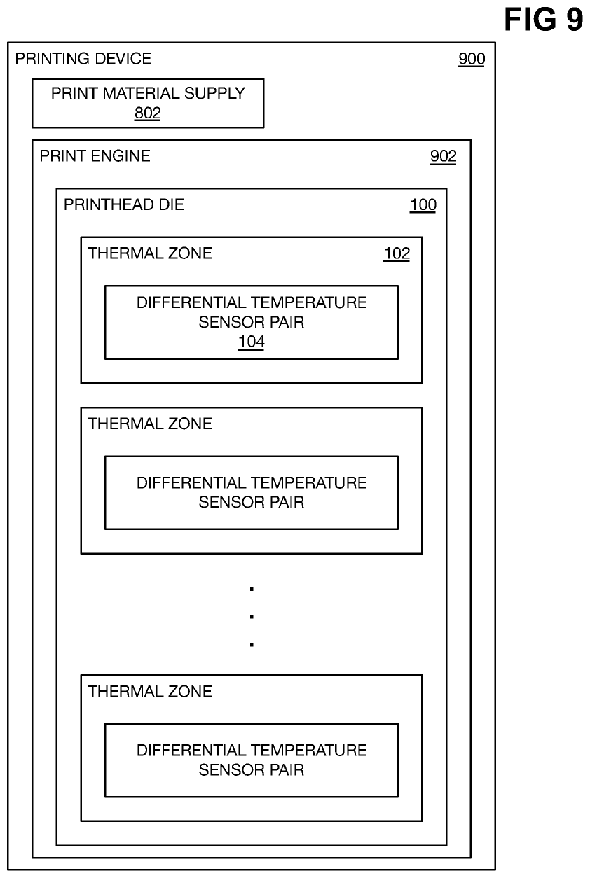

FIG. 9 shows an example printing device 900. The printing device 900 may be a stand-alone printer that can just print. The printing device 900 may be an all-in-one (AIO) or a multifunction printing (MFP) device that can perform other functions, such as copying, scanning, and/or faxing, in addition to printing.

The printing device 900 includes the supply of print material 802, which may be part of the printing cartridge 800 of FIG. 8 that is removably connectable or insertable into the printing device 900. The printing device 900 includes a thermal jet print engine 902 to selectively eject the print fluid. The print engine 902 includes the printhead die 100, which may be part of the cartridge 800.

There may be more than one printhead die 100 within the printing device 900, such as in the case of a color printing device or a pagewide array (PWA) printing device. In a PWA printing device, the dies 100 are stationary and span the width of media sheets, which are individually advanced past the dies 100 as they eject print material. The die 100 includes, for each of a number of thermal zones 102, a pair of differential temperature sensors 104. The relative size scaling factor between the pair of temperature sensors 104 for each thermal zone is constant across the zones 102.

The techniques that have been described herein provide for fine-grain thermal sensing within a thermal jet printhead die, without having to absolutely match physical temperature sensor size across thermal zones. Thermal sensing is achieved in each zone via a differential sensor pair. Just the size of one sensor of a zone relative to the size of the other sensor of the zone has to be matched across zones, which can minimize the space that the sensors occupy on the die.

We claim:

1. A thermal jet printhead die comprising:
a plurality of thermal zones; and
for each thermal zone, a pair of relative size-scaled temperature sensors to differentially sense a temperature of the thermal zone,
wherein a scaling factor between the pair of relative size-scaled temperature sensors for each thermal zone is matched across the thermal zones.

2. The thermal jet printhead die of claim 1, wherein, for each thermal zone, the pair of relative size-scaled temperature sensors comprises:
a first temperature sensor having a first size; and
a second temperature sensor having a second size larger than the first size by the scaling factor.

3. The thermal jet printhead die of claim 2, further comprising:
analog circuitry common to the thermal zones to drive the pair of relative sized-scaled temperature sensors of each thermal zone and to amplify the differentially sensed temperature of each thermal zone.

4. The thermal jet printhead die of claim 2, wherein the analog circuitry is switchably connected to each thermal zone and comprises:
a driving circuit to drive each of the first and second temperature sensors;
a sensing resistor in series with the first temperature sensor, a voltage drop over the sensing resistor proportional to the temperature of the thermal zone; and
an amplifier to amplify the voltage drop over the sensing resistor.

5. The thermal jet printhead die of claim 4, wherein the driving circuit comprises:
a first transistor connected to the first temperature sensor;
a second transistor connected to the second temperature sensor; and
an operational amplifier connected to the first and second temperature sensors to balance a current in each of the first and second temperature sensors.

6. The thermal jet printhead die of claim 4, wherein the sensing resistor is a first resistor, and the amplifier comprises:
a second resistor; and
a transistor in series with the second resistor,
wherein an output voltage between the second resistor and the transistor is an amplification of the voltage drop over the first resistor.

7. The thermal jet printhead die of claim 6, wherein the amplification is equal to a ratio of a current through the second resistor to a current provided by the driving circuit through each of the first and second temperature sensors, multiplied by a ratio of a resistance of the second resistor to a resistance of the first resistor.

8. The thermal jet printhead die of claim 2, further comprising:
for each thermal zone, a plurality of temperature-sensing devices including first devices and second devices, a number of the second devices equal to a number of the first devices multiplied by the scaling factor,
wherein the first devices are electrically connected in parallel to one another and constitute the first temperature sensor,
and wherein the second devices are electrically connected in parallel to one another and constitute the second temperature sensor.

9. The thermal jet printhead die of claim 8, wherein the first devices are spatially interleaved with the second devices over a plurality of contiguous device groups,
and wherein each contiguous device group includes one of the first devices and a number of the second devices equal to the scaling factor.

10. The thermal jet printhead die of claim 2, each of the first temperature sensor and the second temperature sensor comprises a temperature-dependent diode or a temperature-dependent bipolar junction transistor (BJT).

11. The thermal jet printhead die of claim 1, further comprising:
a plurality of jet nozzles organized within a plurality of jetting groups over the thermal zones; and
a plurality of firing resistors corresponding to the jet nozzles and to selectively eject print material through the jet nozzles.

12. A thermal jet printing cartridge for a printing device comprising:
a supply of print material; and
a thermal jet printhead die to selectively eject the print material,
wherein the printhead die comprises, for each of a plurality of thermal zones, a pair of temperature sensors to differentially sense a temperature of the thermal zone, including a first sensor having a first size and a second sensor having a second size,
and wherein a scaling factor of the first size to the second size is constant across the thermal zones.

13. The thermal jet printing cartridge of claim 12, wherein the die further comprises:
analog circuitry common to the thermal zones to drive the pair of temperature sensors of each thermal zone and to amplify the differentially sensed temperature of each thermal zone.

14. A printing device comprising:
a supply of print material; and
a thermal jet print engine to selectively eject the print material and comprising a printhead die,
wherein the printhead die comprises, for each of a plurality of thermal zones, a pair of differential temperature sensors,
and wherein a relative size scaling factor between the pair of differential temperature sensors for each thermal zone is constant across the thermal zones.

15. The printing device of claim 14, wherein the die further comprises:
analog circuitry common to the thermal zones to drive the pair of differential temperature sensors of each thermal zone and to amplify a differentially sensed temperature of each thermal zone.
